(19) United States
(12) Patent Application Publication
(10) Pub. No.: US 2014/0097784 A1
(43) Pub. Date: Apr. 10, 2014

(54) Rotor Control

(71) Applicant: Control Techniques Limited, Newtown (GB)

(72) Inventor: Simon David Hart, Welshpool (GB)

(73) Assignee: Control Techniques Limited, Newtown (GB)

(21) Appl. No.: 14/049,754

(22) Filed: Oct. 9, 2013

(30) Foreign Application Priority Data
Oct. 10, 2012 (GB) 1218159.0

(51) Int. Cl. H02P 25/02

(52) U.S. Cl. CPC H02P 25/021
USPC 318/705

(57) ABSTRACT

A method for controlling a motor at low operational speed is disclosed, wherein the motor comprises a magnetic rotor and a stator arranged to produce a magnetic field responsive to an applied electric current, wherein the method comprises ramping up an electric current applied to a stator from an initial current level to a synchronisation current level over a period of time. The initial current level is less than a minimum current required by the stator to produce a magnetic field having magnetic flux of a sufficient magnitude for synchronising a position of the magnetic rotor with respect to the magnetic field. The synchronisation current level is greater than or equal to the minimum current required to produce a magnetic field having magnetic flux of a sufficient magnitude to synchronise the position of the magnetic rotor with the magnetic field.

### CROSS-REFERENCE TO RELATED APPLICATION

This application claims the benefit and priority of Great Britain Patent Application No. 1218159.0 filed Oct. 10, 2012. The entire disclosure of the above application is incorporated herein by reference.

### FIELD

This disclosure relates to a method and apparatus for controlling a rotor. More specifically, but not exclusively, a method is disclosed for controlling rotation of a rotor of a motor when operating at low rotor speed.

### BACKGROUND

Motors are commonly used to power the operation of a wide range of devices from very small scale machines to much larger assemblies such as elevators (also known as “lifts”). One of the most common forms of motor used, particularly in industrial applications requiring a constant motor speed, are synchronous motors. Synchronous motors synchronise the rotation of a shaft of the motor with a frequency of an AC electrical supply used to power the motor.

In general terms, a synchronous motor comprises a stator and a rotor. The stator includes a number of coils or windings through which electric currents can be fed. The rotor comprises at least one pair of permanent magnets. When an AC current is fed through a winding of the stator, the winding generates a changing magnetic field. Therefore, in a three-phase motor, when the three-phase components of a three-phase AC current are fed through three respective windings, a rotating magnetic field is created in the stator. The rotating magnetic field created in the stator causes rotation of the rotor, and the speed of rotation of the rotor is synchronous with the frequency of the three-phase AC current. The angle between the rotor and the stator produces a resultant net torque, which dictates the net rotational movement of the rotor.

In order for the net rotational movement of the rotor to be in a desired direction and at a desired speed at any given time, the net torque of the rotor must be controlled. The position and phase at which current is injected through the windings in the stator relative to the permanent magnets in the rotor will determine the configuration of the magnetic flux produced by the stator. This will affect the rotational movement imparted by the winding on the rotor, which in turn determines the net torque on the rotor.

When starting up a synchronous motor it is important to ensure that the rotor and stator are correctly synchronised in order to enable the stator to control the rotor and maximise torque. In order to do this it is necessary to determine the relative position between the stator windings and the permanent magnet(s) of the rotor.

While there are various well-known methods for tracking the rotor position, such as closed-loop position-sensorless vector methods, such methods do not function accurately at low speed/low torque due to the low current signals measured and model/parameter inaccuracies.

One way in which this problem can be overcome is by applying a large DC voltage to the stator in order to create a large magnetic field for aligning the rotor with the stator and then apply a large AC voltage to drag the rotor around. However, this solution is inefficient because of the high currents used and can cause problems such as rotor oscillations, which in some applications can be damaging to the structure of one or more of the components of the motor and the application in which the motor is being used.

### SUMMARY

Embodiments of the present invention attempt to mitigate at least some of the above-mentioned problems.

In accordance with an aspect of the invention there is provided a method for controlling a motor at low operational speed. The motor comprises a magnetic rotor and a stator arranged to produce a magnetic field responsive to an applied electric current to control rotation of the magnetic rotor. The method comprises ramping up an electric current applied to a stator from an initial current level to a synchronisation current level over a period of time. The ramping may be a linear ramping or a non-linear ramping. Furthermore, the ramping may be provided over a sufficient period of time so that the rotor is slowly magnetically engaged with the stator thereby reducing unwanted movement of the rotor due to the increasing magnetic field produced by the stator. The initial current level is less than a minimum current required by the stator to produce a magnetic field having magnetic flux of a sufficient magnitude for synchronising a position of the magnetic rotor with respect to the magnetic field. The synchronisation current level is greater than or equal to the minimum current required to produce a magnetic field having magnetic flux of a sufficient magnitude to synchronise the position of the magnetic rotor with the magnetic field.

The length of the period of time may be provided in order to prevent or minimise unwanted movement of the rotor when the rotor synchronises with the magnetic field. This therefore helps to reduce damage to both the motor itself and to the application with which the motor is working.

The ramping up of the electric current applied to the stator may comprise gradually increasing the electric current over the period of time. This also helps to minimise unwanted movement of the rotor.

The electric current may be linearly increased from the initial current level to the synchronisation current level over the period of time.

The initial current level may be at or near to zero. If the current is at or near zero then there is a higher chance that the rotor has stopped rotating which improves the start-up performance and reduces the risk of damage to the rotor during start-up.

The applied electric current may be DC. Consequently, the rotor may be brought into position with respect to the stator before rotation of the rotor begins.

The electric current may be applied as a series of pulses during at least a portion of the initial time period. This may help to improve the control of the rotor during start-up by stopping the rotor from rotating if it is already rotating from a previous excitation.

The electric current may be applied as a series of pulses from the initial current level to an intermediate current level which is between the initial current level and the synchronisation current level. The duration of each pulse may be less than half of the period between each pulse.

The method may further comprise holding the applied electric current at a current level greater than or equal to the minimum current required by the stator to produce a magnetic field of a sufficient magnitude for synchronising a position of the magnetic rotor with respect to the magnetic field for a further period of time. The applied electric current is an AC current during the further period of time. This process may help to enable the rotor to overcome the affects of stiction.

The current level greater than or equal to the minimum current required by the stator to produce a magnetic field of a sufficient magnitude for synchronising a position of the magnetic rotor with respect to the magnetic field during the further period of time may be the synchronisation current level.

The length of the further period of time may be provided for the rotor to overcome the affects of stiction.

A frequency of the applied electric current may be increased over the further period of time.

The method may further comprise, after the applied electric current is held at a current level greater than or equal to the minimum current required by the stator to produce a magnetic field having a magnetic flux of a sufficient magnitude for synchronising a position of the magnetic rotor with respect to the magnetic field, reducing the electric current applied to the stator from the synchronisation current level to a reduced current level over a third period of time. The reduced current level may be lower than the synchronisation current level. The method may also further comprise increasing the applied electric current from the reduced current level to an operational current level over a fourth period of time. The operational current level may be higher than the reduced current level.

A frequency of the applied electric current may be increased to an operational frequency during the fourth period of time. The current and the frequency of the applied electric current may be increased during the fourth period of time so that the operational current level and operational frequency are reached at the same time. A frequency of the applied electric current may be increased during the third period of time. The frequency may be increased linearly during both the third period of time and the fourth period of time.

The electric current applied to the stator at the synchronisation current level may be a DC current.

The reduced current level may be at or close to a minimum current level required to maintain the rotor in synchronisation with the stator. This improves the efficiency of the system.

One or more of the synchronisation current level, the reduced current level, the operational current level, the period of time, the further period of time, the third period of time and the fourth period of time are set according to characteristics of the stator and the rotor. The parameters may be set by a user of the system. Alternatively, these parameters could be set in a factory during a manufacturing process.

The method may further comprise controlling the applied current once the operational current and frequency are reached using a standard motor control process.

According to another aspect of the invention a method for controlling a motor at low operational speed is provided. The motor comprises a magnetic rotor and a stator arranged to produce a magnetic field responsive to an applied electric current to control rotation of the magnetic rotor. The method comprises applying an electric current to the stator at a synchronisation current level. The synchronisation current level is greater than or equal to a minimum current required for the stator to produce a magnetic field having magnetic flux of a sufficient magnitude to synchronise the position of the magnetic rotor with the magnetic field. The method further comprises reducing the electric current applied to the stator from the synchronisation current level to a reduced current level over a period of time. The reduced current level is lower than the synchronisation current level. The method also comprises increasing the applied electric current from the reduced current level to an operational current level over a further period of time. The operational current level is higher than the reduced current level.

A frequency of the applied electric current may be increased to an operational frequency during the further period of time.

The current and the frequency of the applied electric current may be increased during the further period of time so that the operational current level and operational frequency are reached at the same time. A frequency of the applied electric current may be increased during the period of time. The frequency may be increased linearly during both the period of time and the further period of time.

The electric current applied to the stator at the synchronisation current level may be a DC current.

The reduced current level may be at or close to a minimum current level required to maintain the rotor in synchronisation with the stator.

The method may further comprise controlling the applied current once the operational current and frequency are reached using a standard motor control process.

The electric current may be applied to the stator at the synchronisation current level by ramping up an electric current applied to a stator from an initial current level to a synchronisation current level over a first period of time. The initial current level may be less than a minimum current required by the stator to produce a magnetic field having magnetic flux of a sufficient magnitude for synchronising a position of the magnetic rotor with respect to the magnetic field. The synchronisation current level may be greater than or equal to the minimum current required to produce a magnetic field having magnetic flux of a sufficient magnitude to synchronise the position of the magnetic rotor with the magnetic field.

The length of the first period of time may be provided in order to prevent or minimise unwanted movement of the rotor when the rotor synchronises with the magnetic field.

The ramping up of the electric current applied to the stator may comprise gradually increasing the electric current over the first period of time.

The electric current may be linearly increased from the initial current level to the synchronisation current level over the first period of time.

The initial current level may be at or near to zero. The applied electric current during the first period of time may be DC.

The electric current may be applied as a series of pulses during at least a portion of the first period of time. The electric current may be applied as a series of pulses from the initial current level to an intermediate current level which is between the initial current level and the synchronisation current level. The duration of each pulse may be less than half of the period between each pulse.

The method may further comprise holding the applied electric current at a current level greater than or equal to the minimum current required by the stator to produce a magnetic field of a sufficient magnitude for synchronising a position of the magnetic rotor with respect to the magnetic field for a second period of time after the first period of time and before reducing the current. The applied electric current may be an AC current during the second period of time.

The current level greater than or equal to the minimum current required by the stator to produce a magnetic field of a sufficient magnitude for synchronising a position of the magnetic rotor with respect to the magnetic field during the further period of time may be the synchronisation current level.

The length of the further period of time may be provided for the rotor to overcome the affects of stiction.

A frequency of the applied electric current may be increased over the second period of time.

The synchronisation current level, the reduced current level, the operational current level, the period of time and the further period of time may be set according to characteristics of the stator and the rotor. A user may set these parameters. Alternatively, these parameters may be set during a manufacturing process.

According to another aspect of the invention an apparatus for controlling a motor at low operational speed is provided. The motor comprises a magnetic rotor and a stator arranged to produce a magnetic field responsive to an applied electric current to control rotation of the magnetic rotor. The apparatus comprises a processor arranged to perform any of the various methods described herein.

According to yet another aspect of the invention a system is provided comprising a motor comprising a magnetic rotor and a stator arranged to produce a magnetic field responsive to an applied electric current to control rotation of the magnetic rotor, and an apparatus for controlling such a motor using any of the methods described herein. The motor may be a three-phase synchronous motor.

According to a further aspect of the invention a computer-readable medium is provided that is operable, in use, to instruct a computer to perform any of the various methods described herein.

Embodiments of the invention provide a method for simple current controlled starting for a motor, based on user commissioned time intervals. In some embodiments of the invention a purely model based scheme is employed such as a vector control method at higher speeds/torques.

Advantageously, embodiments of the invention do not require complex user configuration.

Conveniently, embodiments of the invention reduce computation and signal processing.

Embodiments of the invention advantageously increase machine efficiency.

### DRAWINGS

Exemplary embodiments of the invention shall now be described with reference to the drawings in which:

FIG. 1 illustrates a structure of a motor; and

FIG. 2 illustrates a motor control procedure.

Throughout the description and the drawings, like reference numerals refer to like parts.

### SPECIFIC DESCRIPTION

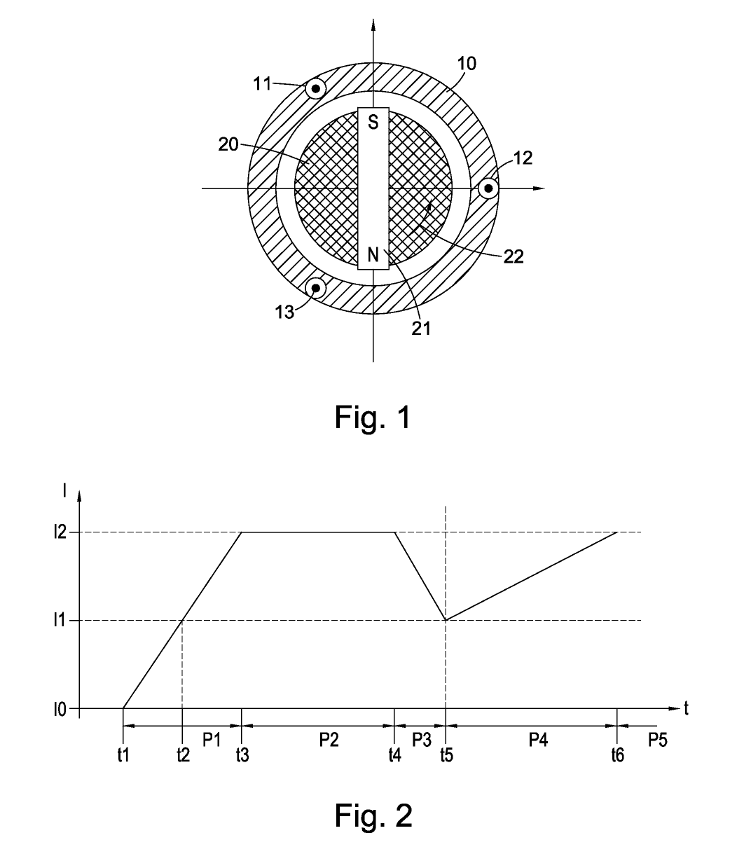

FIG. 1 illustrates a motor arrangement comprising a stator 10 and a rotor 20. The stator 20 and rotor 10 are circular in shape and concentric with one another, the rotor 10 being arranged within the stator 20.

The stator 10 comprises three sets of windings 11, 12, 13 equidistantly spread around the circumference of the stator 10. Each winding is arranged to have one phase of a balanced three-phase current passed therethrough, wherein each of the phase components are provided with a current of equal magnitude and separated from one another in terms of phase by 120°. The phase separation of the three windings 11, 12, 13 effectively cancels out the mechanical separation to provide a sinusoidal field distribution from the stator 10.

The rotor 20 comprises a magnetic member 21 in the form of a single fixed bar magnet running from a first side of the rotor 20 to an other side of the rotor 20, the other side of the rotor being on an opposite side of the rotor to the first side of the rotor. The rotor is rotatable about its shaft or axis which runs longitudinally along the rotor (into the page on FIG. 1).

The sinusoidal magnetic field distribution of the stator 10 drives the rotation of the rotor 20 due to the magnetic interaction of the magnetic member 21 to the sinusoidal magnetic field distribution. The resultant rotation of the rotor 20 is illustrated by arrow 22 in FIG. 1.

In order to initiate rotation of the rotor 20 a rotor control method is provided. This rotor control method shall now be described with reference to FIG. 2.

FIG. 2 illustrates a rotor control method in accordance with a variation in current demand over time.

The first phase of the rotor control method, P1, is provided to synchronise the rotor 20 to the magnetic field of the stator 10 so that rotation of the rotor 20 can be controlled by the stator 10. As the shaft position and speed is not known, the system cannot simply excite the machine at zero frequency with large voltage at an arbitrary angle as this could cause excessive current, and a sudden torque step, which may damage the fan blades due to their considerable inertia.

In the first phase of the rotor control method, P1, between time t1 and t3, a DC voltage is applied to the windings 11, 12, 13 of the stator, the voltage and corresponding current gradually ramping up from a minimum current I0 at time t1 to a current I2 at time t3. The current I2 is greater than or equal to a minimum current required to produce a magnetic field of sufficient strength to synchronise the rotor 20 to the magnetic field produced by the stator 10. Furthermore, the maximum value for the current I2 is limited by the motor rated current.

This ‘soft synchronisation’ process of slowly increasing the current to a synchronisation current reduces an initial unwanted movement of the rotor 20 when it becomes synchronised to the magnetic field of the stator 10. This movement is often known as a synchronisation jump or grab.

If the rotor 20 is still rotating at the time t1 then this could make the synchronisation process more difficult and could cause damage to the rotor when attempting to synchronise it as a rapid deceleration may be involved. For example, in applications such as fans and pumps, there is often a slow motor rotation if there is already a flow of the fluid in which the fan or pump is placed if the fan or pump is not mechanically braked. When there is a rapid deceleration of the blades of a fan, the blades can be damaged. Consequently, during the first phase, the rotor control method takes this into account when attempting to synchronise the rotor 20 with the magnetic field of the stator 10, as discussed below.

During the first phase of the synchronisation process between time t1 and time t2 the current is increased from current I0 to current I1 by applying short pulses of voltage, which slowly increase from time t1 to time t2. Time t1 is set by a user dependent on the requirements of the system. The pulses are set to be of short duration to provide very small torque pulses rather than one large one. Little periods of small deceleration will not damage the fan blades. For example, the duration of the pulse should be less than half of the period between pulses. The exact width of the pulses will depend on the requirements of the system. However, ideally the width of the pulses should be as small as can be managed by the electronic system providing the current. The user should alter the ramp rate based on the needs of the system in order to prevent damage without taking too much time.

At the end of the first phase, P1, the shaft is synchronised and the current demand is at the current level I2. Since only a DC voltage has been applied to the windings 11, 12, 13 of the stator, the output frequency is zero. Consequently, the rotor 20 is synchronised to the stator 10 in terms of position, but remains static.

The second phase of the control process, P2, is provided to overcome rotor stiction. As such, the electricity supplied through the windings 11, 12, 13 becomes an AC signal and the frequency of the AC signal is slowly increased in order to increase the speed of rotation of the rotor 20. The current is kept at the maximum current I2 in order to ensure that maximum torque is provided for overcoming the stiction. This process continues from time t3 until time t4 at which point the stiction should be overcome. The duration of this second phase, P2, is selected to provide sufficient time to ensure that the stiction is overcome and the exact time will therefore dependent on the characteristics of the motor and system in which it is being used.

The third phase, P3, of the control process is provided in order to reduce the current and therefore increase the efficiency of the system. As such, the current is slowly reduced from current I2 to current I1 between time t4 and time t5. This thereby increases the efficiency because the current is reduced to a level just greater than is required to drive the application. In other words, the reduction in current alters the torque angle so that it is nearer to the optimum 90°. It will be appreciated that the reduced current need not be current I1, but could be any current selected for maximising efficiency of the system. However, the reduced current must still be of sufficient magnitude to maintain synchronisation during acceleration given system friction and inertia.

During the third phase, the output frequency is increased. The frequency is preferably increased at a constant rate to prevent, or at least minimise, torque disturbances occurring. When current is increased at a constant acceleration rate a constant torque is provided which is required by the system inertia because the inertial torque is proportional to the change of speed. As the speed increases the frictional torque increases proportionally. At the end of this phase the method moves from being a time based solution to being frequency based since the current increases as the frequency increases to match the frictional loss which is proportional to the speed.

During the fourth phase of the control process, P4, the current and frequency are both increased from time t5 to time t6. This increase is provided to get the speed and torque provided by the motor to their operational states. Due to the increase in rotor speed and corresponding increase in frictional torque an increase in current is required to overcome such frictional torque. The current is shown as increasing to current I2 for ease of illustration, but it will be appreciated that the current could increase to any other suitable current at time t6.

By reducing the current during phase three and then increasing the current during phase four the efficiency of the system is increased because the current required to provide the necessary torque is being supplied to drive the motor because the current into the machine is reduced to just above the ideal amount. If more current is put into the machine than is required then the machine becomes less efficient.

At or after time t6, during the final phase, P5, the motor control can then be provided by any standard control method, such as a vector-based control method, as the motor has reached its normal operating conditions.

It will be appreciated that in alternative embodiments of the invention the stator and rotor may take alternative forms. For example, the rotor may include multiple pole magnets, and the stator may include equivalent multiples of windings.

The various control methods described above may be implemented in hardware or by a computer program.

When implemented by a computer program a computer could be provided having a memory to store the computer program, and a processor to implement the computer program. The processor would then perform the control process for control of the current supplied to the stator. The computer program may include computer code arranged to instruct a computer to perform the functions of one or more of the various methods described above. The computer program and/or the code for performing such methods may be provided to an apparatus, such as a computer, on a computer readable medium. The computer readable medium could be, for example, an electronic, magnetic, optical, electromagnetic, infrared, or semiconductor system, or a propagation medium for data transmission, for example for downloading the code over the Internet. Non-limiting examples of a physical computer readable medium include semiconductor or solid state memory, magnetic tape, a removable computer diskette, a random access memory (RAM), a read-only memory (ROM), a rigid magnetic disc, and an optical disk, such as a CD-ROM, CD-R/W or DVD.

1. A method for controlling a motor at low operational speed, wherein the motor comprises a magnetic rotor and a stator arranged to produce a magnetic field responsive to an applied electric current to control rotation of the magnetic rotor, the method comprising:
ramping up an electric current applied to a stator from an initial current level to a synchronisation current level over a period of time, wherein
the initial current level is less than a minimum current required by the stator to produce a magnetic field having magnetic flux of a sufficient magnitude for synchronising a position of the magnetic rotor with respect to the magnetic field; and
the synchronisation current level is greater than or equal to the minimum current required to produce a magnetic field having magnetic flux of a sufficient magnitude to synchronise the position of the magnetic rotor with the magnetic field.

2. The method according to claim 1, wherein the length of the period of time is provided in order to prevent or minimise unwanted movement of the rotor when the rotor synchronises with the magnetic field.

3. The method according to claim 1, wherein the ramping up of the electric current applied to the stator comprises gradually increasing the electric current over the period of time.

4. The method according to claim 1, wherein the electric current is linearly increased from the initial current level to the synchronisation current level over the period of time.

5-7. (canceled)

8. The method according to claim 1, wherein the electric current is applied as a series of pulses during at least a portion of the initial time period from the initial current level to an intermediate current level which is between the initial current level and the synchronisation current level.

9. The method according to claim 8, wherein the duration of each pulse is less than half of the period between each pulse.

10. The method according to claim 1, further comprising:
holding the applied electric current at a current level greater than or equal to the minimum current required by the stator to produce a magnetic field of a sufficient magnitude for synchronising a position of the magnetic rotor with respect to the magnetic field for a further period of time, wherein the applied electric current is an AC current during the further period of time.

11. The method according to claim 10, wherein the current level greater than or equal to the minimum current required by the stator to produce a magnetic field of a sufficient magnitude for synchronising a position of the magnetic rotor with respect to the magnetic field during the further period of time is the synchronisation current level.

12. (canceled)

13. The method according to claim 10, wherein a frequency of the applied electric current is increased over the further period of time.

14. The method according to claim 10, further comprising:
after the applied electric current is held at a current level greater than or equal to the minimum current required by the stator to produce a magnetic field having a magnetic flux of a sufficient magnitude for synchronising a position of the magnetic rotor with respect to the magnetic field, reducing the electric current applied to the stator from the synchronisation current level to a reduced current level over a third period of time, wherein the reduced current level is lower than the synchronisation current level; and
increasing the applied electric current from the reduced current level to an operational current level over a fourth period of time, wherein the operational current level is higher than the reduced current level.

15. The method according to claim 14, wherein a frequency of the applied electric current is increased to an operational frequency during the fourth period of time.

16. The method according to claim 15, wherein the current and the frequency of the applied electric current are increased during the fourth period of time so that the operational current level and operational frequency are reached at the same time.

17. The method according to claim 14, wherein a frequency of the applied electric current is increased during the third period of time.

18. The method according to claim 15, wherein the frequency is increased linearly during both the third period of time and the fourth period of time.

19-22. (canceled)

23. A method for controlling a motor at low operational speed, wherein the motor comprises a magnetic rotor and a stator arranged to produce a magnetic field responsive to an applied electric current to control rotation of the magnetic rotor, the method comprising:
applying an electric current to the stator at a synchronisation current level, wherein the synchronisation current level is greater than or equal to a minimum current required for the stator to produce a magnetic field having magnetic flux of a sufficient magnitude to synchronise the position of the magnetic rotor with the magnetic field;
reducing the electric current applied to the stator from the synchronisation current level to a reduced current level over a period of time, wherein the reduced current level is lower than the synchronisation current level; and
increasing the applied electric current from the reduced current level to an operational current level over a further period of time, wherein the operational current level is higher than the reduced current level.

24. The method according to claim 23, wherein a frequency of the applied electric current is increased to an operational frequency during the further period of time.

25. The method according to claim 23, wherein the current and the frequency of the applied electric current are increased during the further period of time so that the operational current level and operational frequency are reached at the same time.

26. The method according to claim 23, wherein a frequency of the applied electric current is increased during the period of time.

27. The method according to claim 24, wherein the frequency is increased linearly during both the period of time and the further period of time.

28-30. (canceled)

31. The method according to claim 23, wherein the electric current is applied to the stator at the synchronisation current level by:
ramping up an electric current applied to a stator from an initial current level to a synchronisation current level over a first period of time, wherein
the initial current level is less than a minimum current required by the stator to produce a magnetic field having magnetic flux of a sufficient magnitude for synchronising a position of the magnetic rotor with respect to the magnetic field; and
the synchronisation current level is greater than or equal to the minimum current required to produce a magnetic field having magnetic flux of a sufficient magnitude to synchronise the position of the magnetic rotor with the magnetic field.

32-44. (canceled)

45. An apparatus for controlling a motor at low operational speed, wherein the motor comprises a magnetic rotor and a stator arranged to produce a magnetic field responsive to an applied electric current to control rotation of the magnetic rotor, comprising:
a processor arranged to perform the method of claim 1.

46-47. (canceled)

48. A non-transitory computer-readable medium operable, in use, to instruct a computer to perform the method of claim 1.

49. An apparatus for controlling a motor at low operational speed, wherein the motor comprises a magnetic rotor and a stator arranged to produce a magnetic field responsive to an applied electric current to control rotation of the magnetic rotor, comprising:
a processor arranged to perform the method of claim 23.

50. A non-transitory computer-readable medium operable, in use, to instruct a computer to perform the method of claim 23.
